(19) United States
(12) Patent Application Publication
(10) Pub. No.: US 2024/0328204 A1
(43) Pub. Date: Oct. 3, 2024

(54) Door Lock Assembly

(71) Applicant: William Davis, Denham Springs, LA (US)

(72) Inventor: William Davis, Denham Springs, LA (US)

(21) Appl. No.: 18/128,360

(22) Filed: Mar. 30, 2023

(51) Int. Cl. E05B 55/00; E05B 15/12; E05B 17/20

(52) U.S. Cl. CPC E05B 55/005; E05B 17/2023; E05B 17/2038

(57) ABSTRACT

A door lock assembly includes a door lock that is installed in a door of a building. The door lock includes a pair of door knobs and a latch bolt. The latch bolt engages a recess in a doorjamb when the door is closed for retaining the door in a closed position. Conversely, the latch bolt disengages the recess in the doorjamb when either of the door knobs is rotated thereby facilitating the door to be opened. A pin is extendable though the latch bolt of the door lock when the door is closed such that the pin abuts the door. In this way the latch bolt is inhibited from being urged into an unlocking position thereby inhibiting an intruder from defeating the door lock and opening the door.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lock devices and more particularly pertains to a new lock device for inhibiting an intruder from defeating a lock and opening a door. The device includes a door lock installed in a door which has a pair of door knobs and a latch bolt. The latch bolt has a hole extending through the latch bolt. The device includes a pin that is insertable through the hole to inhibit the latch bolt from being retracted into the door. In this way the door is inhibited from being opened by an intruder that has defeated the door lock.

### (2) Description of Related Art Including Information Disclosed Under 37 CFR 1.97 and 1.98

The prior art relates to lock devices including a door lock which includes a pivoting arm that is extendable beyond a doorjamb and a hook for supporting the pivoting arm. The prior art discloses a door lock device that combines a latch bolt for a door knob and a deadbolt. The prior art discloses an improved inner cylinder lock of a door lock. The prior art discloses a tamper-proof lock that includes a blocking element and a bolt that deforms upon forced movement. The prior art discloses a method of locking a door which involves the step of inserting a pin through a latch to inhibit the latch from moving.

### BRIEF SUMMARY OF THE INVENTION

An embodiment of the disclosure meets the needs presented above by generally comprising a door lock that is installed in a door of a building. The door lock includes a pair of door knobs and a latch bolt. The latch bolt engages a recess in a doorjamb when the door is closed for retaining the door in a closed position. Conversely, the latch bolt disengages the recess in the doorjamb when either of the door knobs is rotated thereby facilitating the door to be opened. A pin is extendable though the latch bolt of the door lock when the door is closed such that the pin abuts the door. In this way the latch bolt is inhibited from being urged into an unlocking position thereby inhibiting an intruder from defeating the door lock and opening the door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a door lock assembly according to an embodiment of the disclosure.

FIG. 2 is an exploded perspective view of an embodiment of the disclosure.

FIG. 3 is a phantom perspective in-use view of an embodiment of the disclosure.

FIG. 4 is a front in-use view of an embodiment of the disclosure.

FIG. 5 is a cross sectional view taken along line 5-5 of FIG. 4 of an embodiment of the disclosure.

### DETAILED DESCRIPTION OF THE INVENTION

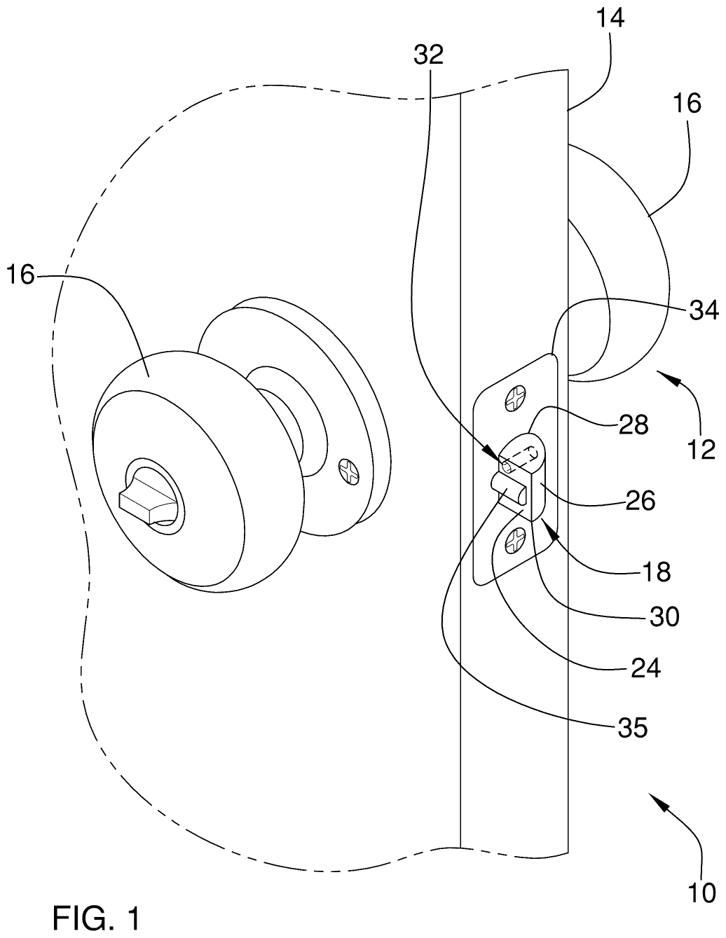

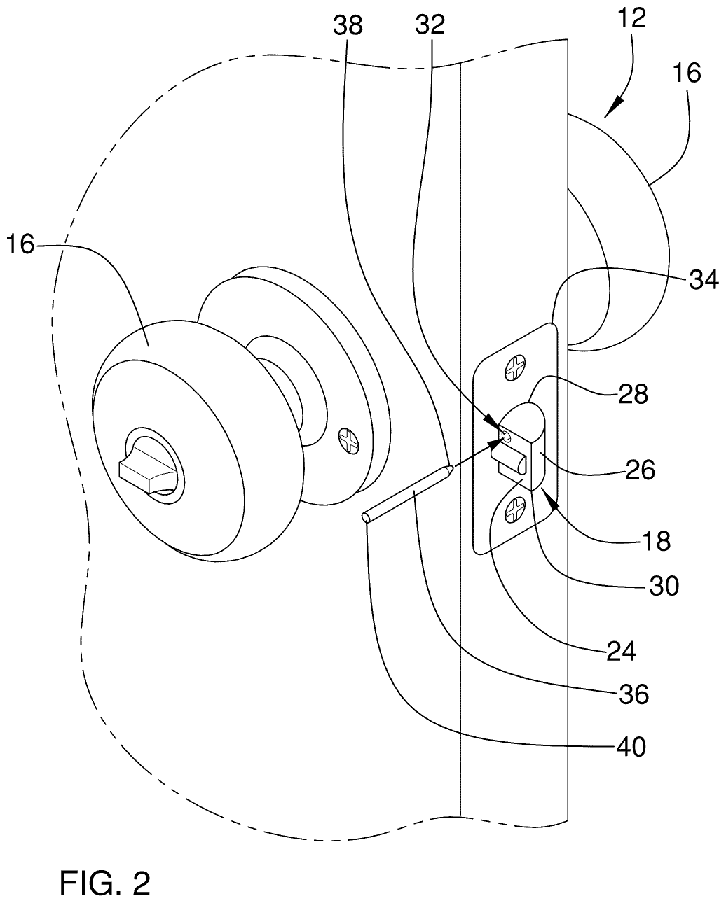

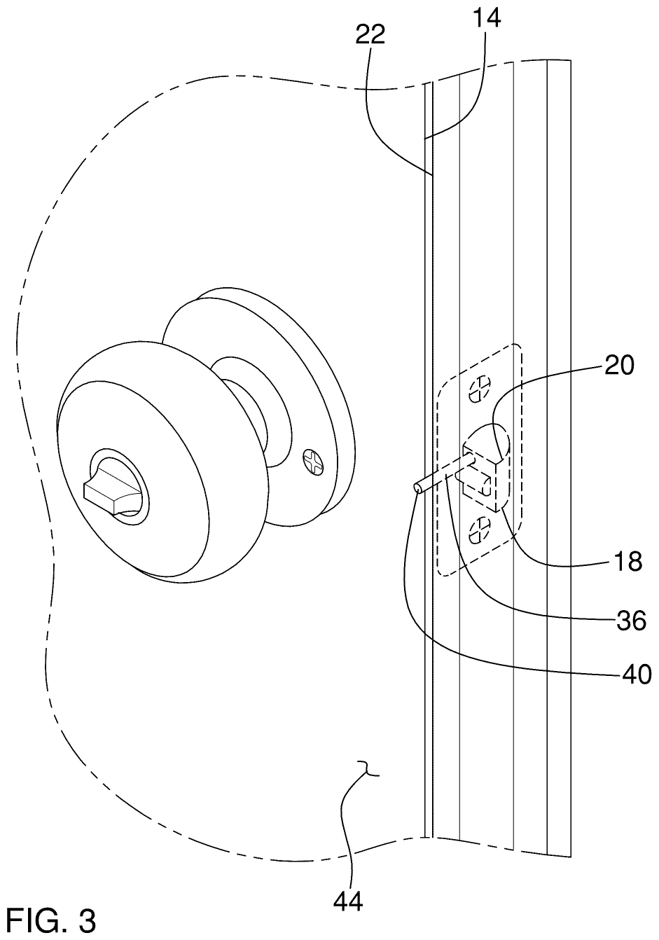

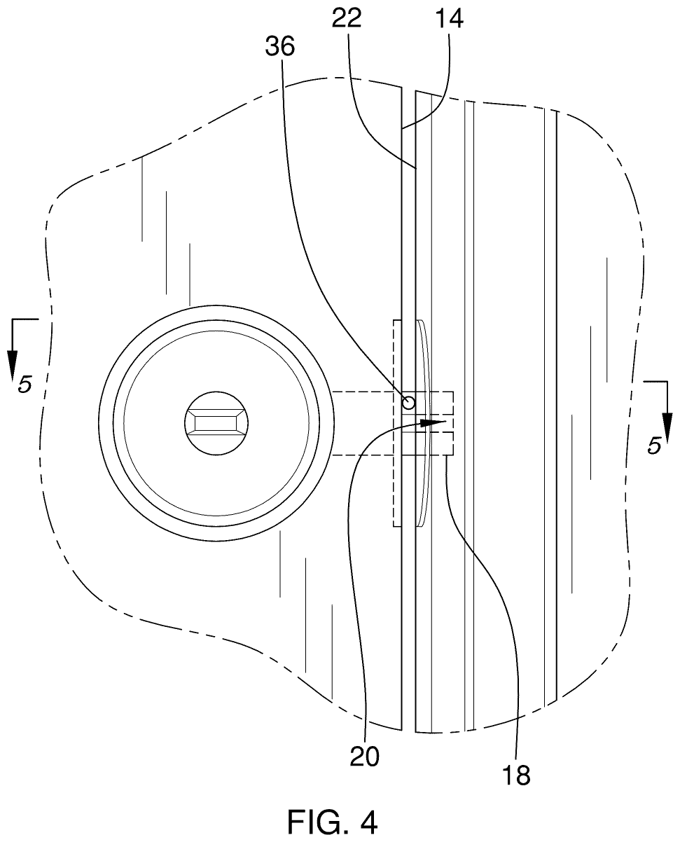

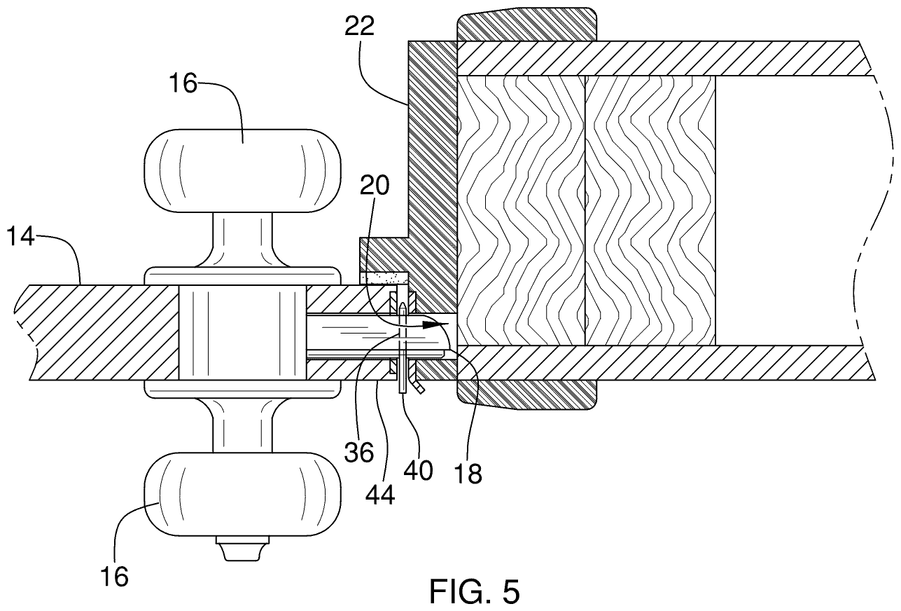

With reference now to the drawings, and in particular to FIGS. 1 through 5 thereof, a new lock device embodying the principles and concepts of an embodiment of the disclosure and generally designated by the reference numeral 10 will be described.

As best illustrated in FIGS. 1 through 5, the door lock assembly 10 generally comprises a door lock 12 that is installed in a door 14 of a building. The building may be a house, for example, and the door 14 may be an exterior door 14 that serves as an entrance into the building. The door lock 12 includes a pair of door knobs 16 and a latch bolt 18. The latch bolt 18 engages a recess 20 in a doorjamb 22 when the door 14 is closed for retaining the door 14 in a closed position. Conversely, the latch bolt 18 disengages the recess 20 in the doorjamb 22 when either of the door knobs 16 is rotated thereby facilitating the door 14 to be opened. The door lock 12 may be a keyed door lock of any conventional design that would commonly be employed in residential construction.

The latch bolt 18 has a front side 24, a back side 26, a top side 28 and a bottom side 30 and each of the front side 24, the top side 28 and the bottom side 30 is planar. The back side 26 is concavely arcuate with respect to the front side 24 such that the back side 26 intersects the front side 24. The latch bolt 18 has a hole 32 extending through the front side 24 and the back side 26 and the hole 32 may be positioned on either side of a dead bolt plunger 35 of the latch bolt 18. Furthermore, the hole 32 is spaced from an intersection between the front side 24 and the back side 26 such that the hole 32 is positioned closer to a face plate 34 in the door 14 than the intersection when the latch bolt 18 is biased to extend outwardly from the face plate 34.

A pin 36 is extendable though the latch bolt 18 of the door lock 12 when the door 14 is closed such that the pin 36 rests against the door 14. In this way the latch bolt 18 is inhibited from being urged into an unlocking position thereby inhibiting an intruder from defeating the door lock 12 and opening the door 14. The pin 36 has a first end 38 and a second end 40 and the first end 38 is insertable into the hole 32 having the pin 36 resting against the face plate 34. In this way the latch bolt 18 is inhibited from being retracted into the face plate 34.

In use, the door 14 is closed such that the latch bolt 18 extends into the recess 20 in the doorjamb 22. The pin 36 is inserted between the door 14 and the doorjamb 22 to facilitate the pin 36 to extend into the hole 32 in the latch bolt 18. In this way the pin 36 inhibits the latch bolt 18 from being retracted into the face plate 34 when either of the door knobs 16 is rotated. Thus, the door 14 cannot be opened even if an intruder is able to defeat the locking mechanism of the door lock 12. In this way an occupant of the building can feel completely secure. Furthermore, the occupant can remove the pin 36 at any time to facilitate the door lock 12 to operate normally.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door lock assembly for inhibiting a locking mechanism in a door from being defeated by an intruder, said assembly comprising:
a door lock being installed in a door of a building, said door lock including a pair of door knobs and a latch bolt, said latch bolt engaging a recess in a doorjamb when said door is closed for retaining said door in a closed position, said latch bolt disengaging said recess in said doorjamb when either of said door knobs is rotated thereby facilitating said door to be opened; and
a pin being extendable though said latch bolt of said door lock when said door is closed such that said pin abuts said door thereby inhibiting said latch bolt from being urged into an unlocking position wherein said pin is configured to inhibit an intruder from being able to defeat said door lock and open said door.

2. The assembly according to claim 1, wherein:
said latch bolt has a front side, a back side, a top side and a bottom side, each of said front side and said top side and said bottom side being planar, said back side being concavely arcuate with respect to said front side such that said back side intersects said front side; and
said latch bolt has a hole extending through said front side and said back side, said hole being spaced from an intersection between said front side and said back side such that said hole is positioned closer to a face plate in said door than said intersection when said latch bolt is biased to extend outwardly from said face plate.

3. The assembly according to claim 2, wherein:
said pin has a first end and a second end; and
said first end is insertable into said hole having said pin resting against said face plate thereby inhibiting said latch bolt from being retracted into said face plate.

4. A door lock assembly for inhibiting a locking mechanism in a door from being defeated by an intruder, said assembly comprising:
a door lock being installed in a door of a building, said door lock including a pair of door knobs and a latch bolt, said latch bolt engaging a recess in a doorjamb when said door is closed for retaining said door in a closed position, said latch bolt disengaging said recess in said doorjamb when either of said door knobs is rotated thereby facilitating said door to be opened, said latch bolt having a front side, a back side, a top side and a bottom side, each of said front side and said top side and said bottom side being planar, said back side being concavely arcuate with respect to said front side such that said back side intersects said front side, said latch bolt having a hole extending through said front side and said back side, said hole being spaced from an intersection between said front side and said back side such that said hole is positioned closer to a face plate in said door than said intersection when said latch bolt is biased to extend outwardly from said face plate; and
a pin being extendable though said latch bolt of said door lock when said door is closed such that said pin abuts said door thereby inhibiting said latch bolt from being urged into an unlocking position wherein said pin is configured to inhibit an intruder from being able to defeat said door lock and open said door, said pin having a first end and a second end, said first end being insertable into said hole having said pin resting against said face plate thereby inhibiting said latch bolt from being retracted into said face plate.

5. A method of inhibiting a door lock from being defeated by an intruder, the steps of the method comprising:
providing a door being hingedly positioned in a doorjamb;
providing a door lock having a pair of knobs and a latch bolt extending outwardly from a face plate of said door, said latch bolt being biased to extend away from said face plate, said latch bolt being recessed into said face plate when either of said knobs is rotated;
providing a pin having a first end and a second end;
drilling a hole through a front surface and a back surface of said latch bolt; and
closing said door such that said latch bolt extends into a recess in said doorjamb; and
inserting said pin between said door and said doorjamb thereby facilitating said pin to extend into said hole in said latch bolt such that said pin inhibits said latch bolt from being recessed into said face plate wherein said pin is configured to inhibit an intruder from defeating said door lock and opening said door.
